(19) United States
(12) Patent Application Publication
(10) Pub. No.: US 2024/0221079 A1
(43) Pub. Date: Jul. 4, 2024

(54) MACHINE LEARNING EVALUATION OF CRYPTOGRPHICALLY SIGNED TRANSACTIONS AND ASSET TOKENIZATION

(71) Applicant: Applied Physics, Inc., New York, NY (US)

(72) Inventors: Gianni Martire, New York, NY (US); Haydn Vestal, Austin, TX (US)

(21) Appl. No.: 18/402,534

(22) Filed: Jan. 2, 2024

Related U.S. Application Data
(60) Provisional application No. 63/436,461, filed on Dec. 30, 2022.
(60) Provisional application No. 63/436,462, filed on Dec. 30, 2022.

(51) Int. Cl. G06Q 40/04

(52) U.S. Cl. CPC G06Q 40/04

(57) ABSTRACT

Systems and methods can include a marketplace for securitized intellectual property with tokenization of shares and clearance and settlement of transfers. Tokenization can include maintaining a marketplace for securitized IP, receiving a request from an authorized entity to register a security, and registering the security within the marketplace. Registering can include receiving an escrow account for the security, executing a contract, and generating a number of shares for the security for exchange within the marketplace. Clearance and settlement of transfers can include receiving a trading request, calculating a total price for the trading request, and processing the trading request. Processing can include generating a unique token for the trading request, executing a transfer of the shares from a seller to a clearinghouse application, executing a transfer of currency from a buyer to the clearinghouse application, and executing a transfer of the shares from the clearinghouse application to the buyer.

### CROSS-REFERENCE TO RELATED APPLICATIONS

This application claims the benefit of U.S. Provisional Patent Application No. 63/436,461 filed Dec. 30, 2023, and titled “MARKETPLACE FOR SECURITIZED INTELLECTUAL PROPERTY WITH CLEARANCE AND SETTLEMENT OF TRANSFERS,” which application is hereby incorporated by reference in its entirety herein. This application also claims the benefit of U.S. Provisional Patent Application No. 63/436,462 filed Dec. 30, 2023, entitled “MARKETPLACE FOR SECURITIZED INTELLECTUAL PROPERTY WITH TOKENIZATION OF SHARES,” which application is also hereby incorporated by reference in its entirety herein.

### TECHNICAL FIELD

The present disclosure relates generally to systems for financial trading, and more particularly, to systems and methods for machine learning based document identification and tokenization.

### SUMMARY

It is an advantage of the present disclosure to provide systems and methods for machine learning based document identification and tokenization. This can include use of a marketplace, comprising one or more servers, for securitized intellectual property (“IP”) with tokenization of shares and clearance and settlement of transfers.

In various embodiments of the present disclosure, methods of utilizing a marketplace, comprising one or more servers, for securitized intellectual property with clearance and settlement of transfers are provided. Pertinent process steps can include receiving a trading request within a marketplace for securitized IP, calculating a total price for the trading request, and processing the trading request. The received trading request can correspond to at least a subset of a plurality of listed shares of a security associated with one or more IP assets and can represent a purchase request or a sale request. Calculating the total price can be based on the subset of shares in the trading request. Processing the trading request can include generating a unique token for the trading request, executing a transfer of shares from a seller of the shares to a clearinghouse application, executing a transfer of currency in the amount of the purchase price from a buyer to the clearinghouse application, and executing a transfer of the shares from the clearinghouse application to the buyer and a transfer of the currency from the clearinghouse application to the seller.

In various detailed embodiments, additional process steps can include receiving a determination from the clearinghouse application that the trading request pertains to a trade that would lead to a change in the price of the security beyond a price change threshold and then rejecting the trading request based on the determination. Other process steps can include receiving a determination from the clearinghouse application that the trading request constitutes a request to lend shares to a borrower and then rejecting the trading request based on the determination. In some embodiments, the unique token can include a unique transaction identification number. The unique token can be associated with at least one of a user account of a buyer within the marketplace, a purchase price for the trading request, and one or more sources of the purchased shares. The one or more sources of the purchased shares can each be associated with unique tokens different from the unique token associated with the trading request. Other process steps can include receiving a request for a compliance report for the completed trade based on the trading request and then generating a report of the cost basis of the shares within the trading request based on the information associated with the trading request and sending the report to one or more regulatory agencies for compliance purposes.

In some arrangements, the currency accepted by the clearinghouse can be a cryptocurrency and the purchase price can be denominated in the cryptocurrency. Transfer of the cryptocurrency can be performed via a wallet associated with a buyer account. Further process steps can include writing details of the trade to a blockchain as a block representing a discrete transaction, wherein the blockchain is accessible to at least all users within the exchange who are listed as traders, performing a verification check of one or more of the trade details on the blockchain, the trade details comprising at least the purchase price for the trade and availability of funds associated with the buyer, or marking the verification check as failed based on detecting, during the verification check, evidence of one or more of fraud, market manipulation, and insufficient funds. Performing the verification check can include receiving a manual approval for the trade if the purchase price for the trade exceeds a specified threshold price for manual approval.

Still further process steps can include depositing, at specified intervals, revenue pertaining to the IP security into an escrow account pertaining to the security, receiving a request to withdraw at least a subset of the revenue from the escrow account, and withdrawing, based on the withdrawal request, at least a subset of the revenue from the escrow account to a wallet associated with the seller. Withdrawing a subset of revenue from the escrow account can be performed upon verification that one or more withdrawal conditions are satisfied. Withdrawal conditions can include revenue needing to be withdrawn for litigation purposes, revenue needing to be paid out to shareholders as dividend payments, or both.

In further embodiments, a system can include one or more processors configured to perform operations. Such operations can include receiving a trading request within a marketplace for securitized IP, calculating a total price for the trading request, and processing the trading request. The received trading request can correspond to at least a subset of a plurality of listed shares of a security associated with one or more IP assets and can represent a purchase request or a sale request. Calculating the total price can be based on the subset of shares in the trading request. Processing the trading request can include generating a application and the trading request, executing a transfer of shares from a seller of the shares to a clearinghouse application, executing a transfer of currency in the amount of the purchase price from a buyer to the clearinghouse application, and executing a transfer of the shares from the clearinghouse application to the buyer and a transfer of the currency from the clearinghouse application to the seller. In some arrangements, the one or more processors can be further configured to perform the operations of executing a cryptographic signing of the trade associated with the trading request, the cryptographic signing being executed using a private key associated with an account of the buyer, and also verifying that the trade associated with the trading request has been cryptographically signed, the verification being performed using a public key associated with the account of the seller.

In further embodiments, a non-transitory computer-readable medium can contain instructions that include instructions for receiving a trading request within a marketplace for securitized IP, instructions for calculating a total price for the trading request, and instructions for processing the trading request. Again, the received trading request can correspond to at least a subset of a plurality of listed shares of a security associated with one or more IP assets and can represent a purchase request or a sale request. Calculating the total price can be based on the subset of shares in the trading request. Processing the trading request can include generating a application and the trading request, executing a transfer of shares from a seller of the shares to a clearinghouse application, executing a transfer of currency in the amount of the purchase price from a buyer to the clearinghouse application, and executing a transfer of the shares from the clearinghouse application to the buyer and a transfer of the currency from the clearinghouse application to the seller. In some arrangements, the one or more processors can be further configured to perform the operations of executing a cryptographic signing of the trade associated with the trading request, the cryptographic signing being executed using a private key associated with an account of the buyer, and also verifying that the trade associated with the trading request has been cryptographically signed, the verification being performed using a public key associated with the account of the seller.

In various further embodiments of the present disclosure, methods of using a marketplace for securitized IP with clearance and settlement of transfers are provided. Pertinent process steps can include maintaining a marketplace for securitized IP, receiving a request to register a security, registering the security, generating shares for the security, publicly listing one or more of the shares, and depositing gross revenue. The marketplace can include a plurality of users, each associated with an account. The request can be from an authorized entity to register a security within the marketplace with the security being associated with one or more specified IP assets. The security can be registered within the marketplace and registering can include receiving an escrow account for the security, executing a contract stipulating that all gross revenue from the IP assets is to be paid into the escrow account for distribution to one or more security owners, and generating a plurality of shares for the security for exchange within the marketplace. One or more shares can be publicly listed within the marketplace based on a request from the authorized entity to list the shares. Gross revenues pertaining to the security can be deposited into the escrow account at specified intervals.

In various detailed embodiments, the IP asset can represent one or more of a patent, a pending patent application, and/or a peer-reviewed article. An added process step can involve distributing, at a specified time interval, funds from the escrow account as dividends that are divided among the security owners. The authorized entity can retain a majority stake in the security as a security owner. The contract can be a smart contract. The contract can further stipulate that the authorized entity agrees not to enter into any other contract with respect to distribution of gross revenue from the IP assets. Generating shares for the security can include generating a positive integer number of shares for the security such that the shares of the security cannot be fractionalized. In some arrangements, the quantity of shares for the security cannot be modified once the shares have been generated.

In further detailed embodiments, additional process steps can include receiving a request to modify the total number of shares for the security within the marketplace and then rejecting the request. Additional process steps can also include receiving a request to distribute one or more of the shares for the security to one or more compensated employees of the authorized entity and then distributing the shares to the compensated employees via the marketplace. Shares for the security can be listed within the marketplace along with one or more pieces of information pertaining to the security. The information can include one or more of a type of IP asset associated with the shares, reputation of the issuer of the shares, and skill of the compensated employees associated with the IP asset. Still further process steps can include paying, at specified intervals, at least a subset of the revenue in the escrow account to shareholders of the security as dividend payments, and also prior to generating the plurality of shares for the security, reviewing the one or more specified IP assets associated with the security for approval to be listed within the marketplace.

In further embodiments, a system can include one or more processors configured to perform operations. Such operations can include maintaining a marketplace for securitized IP, receiving a request to register a security, registering the security, generating shares for the security, publicly listing one or more of the shares, and depositing gross revenue. The marketplace can include a plurality of users, each associated with an account. The request can be from an authorized entity to register a security within the marketplace with the security being associated with one or more specified IP assets. The security can be registered within the marketplace and registering can include receiving an escrow account for the security, executing a contract stipulating that all gross revenue from the IP assets is to be paid into the escrow account for distribution to one or more security owners, and generating a plurality of shares for the security for exchange within the marketplace. One or more shares can be publicly listed within the marketplace based on a request from the authorized entity to list the shares. Gross revenues pertaining to the security can be deposited into the escrow account at specified intervals.

In various detailed embodiments, registering the security can include determining a nominal fair value for the security, the nominal fair value representing a value for purchasing a reserve of shares of the security in order to provide liquidity to the market. The determination can be performed via one or more artificial intelligence (“AI”) models. Inputs to the one or more AI models can include one or more of the authorized entity associated with the security, one or more employees of the authorized entity who worked on the one or more IP assets associated with the security, one or more security owners, one or more exchange-traded funds (“ETFs”) which contain the security, and buy-side and sell-side pressure and volume for the security. Outputs of the one or more AI models can include one or more of a valuation model for an arbitrary security and volume and volatility predictions for the securities.

In yet further embodiments, a non-transitory computer-readable medium can contain instructions that include instructions for maintaining a marketplace for securitized IP, instruction for receiving a request to register a security, instructions for registering the security, instructions for generating shares for the security, instructions for publicly listing one or more of the shares, and instructions for depositing gross revenue. The marketplace can include a plurality of users, each associated with an account. The request can be from an authorized entity to register a security within the marketplace with the security being associated with one or more specified IP assets. The security can be registered within the marketplace and registering can include receiving an escrow account for the security, executing a contract stipulating that all gross revenue from the IP assets is to be paid into the escrow account for distribution to one or more security owners, and generating a plurality of shares for the security for exchange within the marketplace. One or more shares can be publicly listed within the marketplace based on a request from the authorized entity to list the shares. Gross revenues pertaining to the security can be deposited into the escrow account at specified intervals.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures, arrangements, and methods for machine learning based document identification and tokenization, which can include a marketplace for securitized intellectual property with tokenization of shares and clearance and settlement of transfers. These drawings in no way limit any changes in form and detail that may be made to the disclosure by one skilled in the art without departing from the spirit and scope of the disclosure.

FIG. 1 is a diagram illustrating an exemplary environment in which some embodiments may operate.

FIG. 2A is a diagram illustrating an exemplary computer system that may execute instructions to perform some of the methods herein relating to tokenization of IP securities.

FIG. 2B is a flow chart illustrating an exemplary method that may be performed in some embodiments relating to tokenization of IP securities.

FIG. 3A is a diagram illustrating an exemplary computer system that may execute instructions to perform some of the methods herein relating to trading of IP securities within a marketplace.

FIG. 3B is a flow chart illustrating an exemplary method that may be performed in some embodiments relating to trading of IP securities within a marketplace.

FIG. 4 is a diagram illustrating one example embodiment of a dependency graph for categorical feature embedding in an automated valuation mechanism, in accordance with some embodiments.

FIG. 5 is a diagram illustrating one example embodiment of an artificial intelligence (hereinafter “AI”) model diagram with prediction flow for an automated valuation mechanism, in accordance with some embodiments.

FIG. 6 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Financialization is the process by which financial markets come to encompass an ever-greater proportion of real economic activity. It is a representation of an ever-greater share of the market economy by ever-more-precise tradable financial instruments. When done responsibly, financialization of previously illiquid, i.e., practically untradable assets makes the overall economy more efficient by creating new markets for goods and services and connecting those markets to institutional capital. For example, recent companies have successfully created new markets for homeowners and car owners to sell time-limited access to their assets; even though these services could have been possible beforehand, it was not practical to offer them for sale without the marketplace to provide liquidity.

Today, a disproportionate portion of the total capitalization of equity markets are taken up by “mega-cap” stocks worth billions or trillions of dollars. At the same time, newer and smaller companies are deferring public offerings and the associated compliance costs for as long as possible, which has the unfortunate consequence of negating the value of their most valuable employees' stock compensation by keeping it almost completely illiquid. Implementing a workaround for this untenable situation will bypass much of the risk and regulatory burden of a full-scale initial public offering (“IPO”), greatly reducing expenses and avoiding years of keeping valuable employees and investors waiting.

Thus, there is a need in the field of financial trading to create a new and useful system and method for providing a marketplace for trading shares of IP securities. The source of the problem, as discovered by the inventors, is a lack of an exchange for securitized IP assets, including the process of tokenization of IP securities, as well as the clearance and settlement of trades within a securitized IP marketplace. Such an exchange may take the form of, in some embodiments, a purpose-built blockchain for IP securities associated with IP assets which actually provides a concrete cost and regulatory advantage over the system it replaces. A financial instrument which allows securitizing the component properties of an organization such as, for example, a corporation, without the administrative or regulatory overhead of spinning out individual subsidiary corporations, will make equity markets more efficient by allowing investors to connect with individual properties, allowing employers to tailor employee incentive plans to specific projects, and allowing compensated employees to liquidate their stake in their employer's business irrespective of whether their employer is a publicly traded corporation.

As one example use case, an organization may be a privately funded think which develops its own IP assets and generates revenue through licensing and consulting related to that IP. Securitizing the IP assets themselves would allow this organization to compensate employees proportionally to their contributions to specific properties. It also would allow the organization to protect employee stock compensation from dilution as the organization continues to raise larger funding rounds.

Another use case may involve a very high-profile umbrella organization which has restructured in such a way that its investors suddenly have visibility into the cash flow of the individual organizations under that umbrella. A few large institutional investors are unhappy with the amount of money the umbrella organization was investing internally in speculative businesses, leading the umbrella organization to cancel a number of the related projects for those speculative businesses despite many other investors appreciating the company's willingness to engage in these speculative ventures, and despite many employees being willing to accept a different compensation package rather than lose their jobs. Because there was no mechanism for investors or employees to tailor their investment portfolio to individual speculative ideas and intellectual property assets, the market fails to operate efficiently.

Another use case involves mergers and acquisitions, which form a significant portion of private equity transactions. Mergers and acquisitions can typically require a restructuring of one or both businesses depending on the motivation for the transaction. For example, in a vertical integration, two companies may seek to reduce overall costs by pooling productive assets and eliminating administrative redundancies. For instance, one target company may be considered of little value except for its particularly talented employees. Such transactions could be made more efficient and fairer by allowing the market to value the individual corporate properties which may or may not be the desired targets of the transaction.

Currently, the only way for a corporation to securitize a single property is to spin it out into its own subsidiary with its own, e.g., tax identification number, payroll, executives, reporting apparatus and more. The administrative costs involved are prohibitive even for well-established and profitable properties, and often completely unjustifiable for new and speculative properties. Any new property, especially a pre-revenue property, is inherently difficult to value because of the lack of any performance history, and is by default illiquid because of, e.g., lack of qualified buyers and the legal restrictions on trading by compensated employees (who may be classified as insiders). The primary technical challenge of implementing a marketplace for securitized intellectual property is the challenge of valuing and providing liquidity to a large basket of individually securitized assets, most of which are completely illiquid on their own, at an absolute minimum of administrative cost. To this end, some embodiments of the marketplace can include a valuation mechanism which is used to provide valuation of IP assets for securities which lack performance history and other common data used for valuation, as will be discussed in more detail further below.

In one embodiment directed to tokenization of IP securities, the system maintains a marketplace for securitized IP including a number of users, each associated with an account; receives a request from an authorized entity to register a security within the marketplace, the security being associated with one or more specified IP assets; registers the security within the marketplace, where registering includes: receiving an escrow account for the security, executing a contract stipulating that all gross revenue from the IP assets is to be paid into the escrow account for distribution to one or more security owners, and generating a number of shares for the security for exchange within the marketplace; publicly lists, within the marketplace, one or more of the shares for the security based on a request from the authorized entity to list the shares; and deposits, at a specified interval, gross revenues pertaining to the security into the escrow account.

In another embodiment directed to clearance and settlement of trades within a securitized IP marketplace, the system receives a trading request corresponding to at least a subset of listed shares of a security associated with one or more IP assets, where the trading request represents one of a purchase request or a sale request; calculates a total price for the trading request based on the subset of shares in the trading request; and processes the trading request by: generating a unique token for the trading request; executes a transfer of the shares from a seller of the shares to a clearinghouse application; executes a transfer of currency in the amount of the purchase price from a buyer to the clearinghouse application; and executes a transfer of the shares from the clearinghouse application to the buyer and a transfer of the currency from the clearinghouse application to the seller.

In some embodiments, various features of the securitized IP marketplace may be implemented using blockchain and/or smart contract technologies. A blockchain is a list of data blocks linked together through the use of cryptographic functions. A blockchain begins with a genesis block, and all subsequent blocks contain cryptographic hashes of the prior block and a batch of new transactions. This approach secures the integrity of transaction records on the blockchain with respect to the complexity of the hash function in use. In some scenarios, use of a blockchain by the system allows for a distributed marketplace. For example, institutional customers of the maintaining entity may be able to run the software that powers the marketplace by themselves, using their preferred sets of resources and/or hardware (whether via cloud-based services or owned directly by them), without the need for such institutional customers to develop their own version of the marketplace.

Additionally or alternatively, in some scenarios, use of a blockchain by the system may lead to improved market governance relative to existing stock markets. One advantage of blockchain architecture is that it can enable a configuration where all participants are running the same software. For example, the blockchain architecture may allow all participants to share a single replicated database and methods to authorize access to that database. This provides the market operator (i.e., the software publisher) with much more control over the behavior of the exchange than what was previously possible. Previously, for example, major banks and brokers would implement their own trading platforms that mostly communicate via Financial Information Exchange Protocol (“FIX”). As such, for example, the New York Stock Exchange (“NYSE”) would not be able to simply roll out a new rule, such as, e.g., prohibiting lending shares or rejecting orders which would case a price change greater than 5%, because there was no automated way to update every trading platform connected to the exchange and there was no way to ban traders who refused to obey the new rule. However, with the new possibilities for configuration using blockchain architecture, this sort of introduction of new rules and governance for them would be possible.

In some embodiments, various features may be implemented using cryptocurrency technologies. In some embodiments, virtual wallets can be used to facilitate blockchain transactions. In some embodiments, virtual wallets can be used to maintain funds in various currencies, including fiat currencies and/or cryptocurrencies. Smart contracts are self-executing programs that are stored on the blockchain which run automatically when pre-specified conditions are satisfied.

Further areas of applicability of the present disclosure will become apparent from the remainder of the detailed description, the claims, and the drawings. The detailed description and specific examples are intended for illustration only and are not intended to limit the scope of the disclosure.

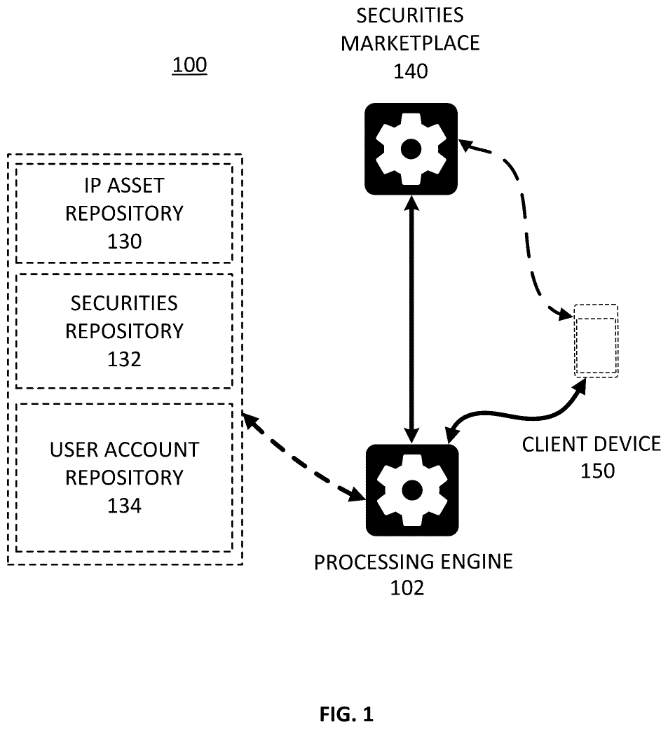

FIG. 1 is a diagram illustrating an exemplary environment in which some embodiments may operate. In the exemplary environment 100, a client device 150 is connected to a processing engine 102 and a securities marketplace 140. The processing engine 102 is connected to the securities marketplace 140, and optionally connected to one or more repositories and/or databases, including, e.g., an IP asset repository 130, securities repository 132, and/or a user account repository 134. One or more of the databases may be combined or split into multiple databases. The client device 150 in this environment may be a computer, and the securities marketplace 140 and processing engine 102 may be applications or software hosted on a computer or multiple computers which are communicatively coupled via remote server or locally.

The exemplary environment 100 is illustrated with only one client device, one processing engine, and one securities marketplace, though in practice there may be more or fewer additional client devices, processing engines, and/or securities marketplaces. In some embodiments, the client device(s), processing engine, and/or securities marketplace may be part of the same computer or device.

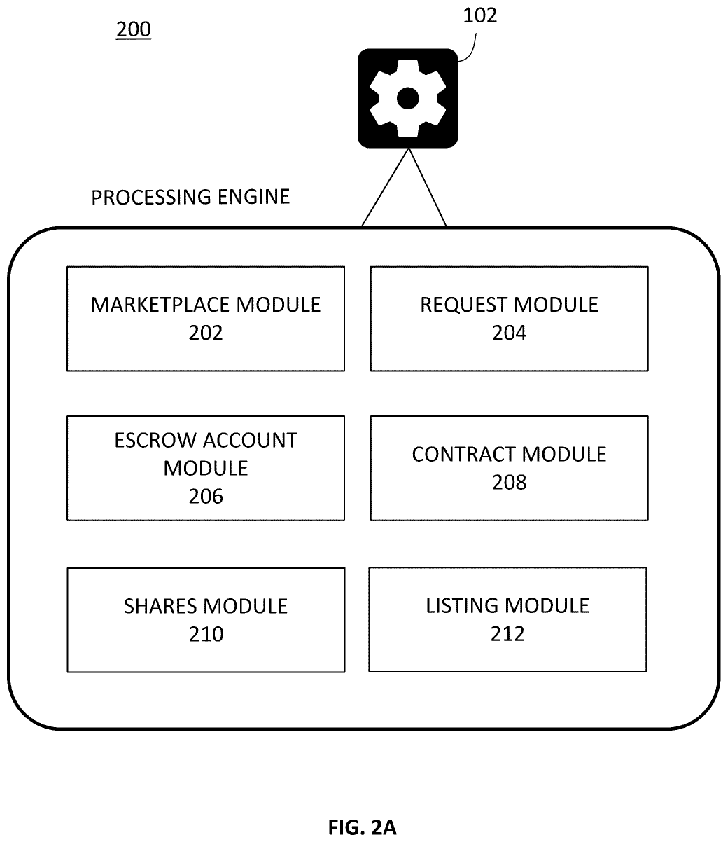

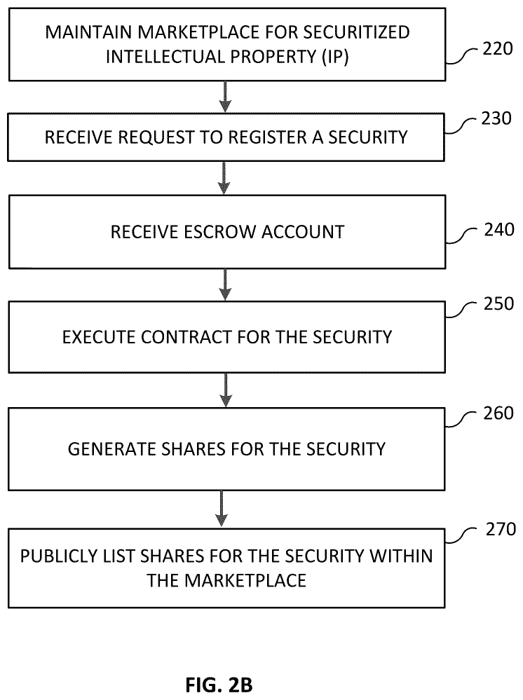

In an embodiment, the processing engine 102 may perform the exemplary method of FIG. 2 or other method herein and, as a result, provide a marketplace for trading shares of IP securities. In some embodiments, this may be accomplished via communication with the client device, processing engine, securities marketplace, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

The client device 150 is a device capable of capturing, sending, and receiving data. In some embodiments, the client device is a computing device capable of hosting and executing one or more applications or other programs capable of capturing, sending and/or receiving data. In some embodiments, the client device may be a computer desktop or laptop, mobile phone, virtual assistant, virtual reality or augmented reality device, wearable, or any other suitable device capable of capturing, sending, and receiving information. In some embodiments, the processing engine 102 and/or securities marketplace 140 may be hosted in whole or in part as an application or web service executed on the client device 150. In some embodiments, one or more of the securities marketplace 140, processing engine 102, and client device 150 may be the same device. In some embodiments, the client device 150 is associated with a first user account within a securities marketplace, and one or more additional client device(s) may be associated with additional user account(s) within the securities marketplace.

In some embodiments, optional repositories can include an IP assets repository 130, a securities repository 132, and/or a user account repository 134. The optional repositories function to store and/or maintain, respectively, information and/or documents pertaining to IP assets; information pertaining to IP securities; and information relating to users of the securities marketplace and their associated accounts within the platform. The optional database(s) may also store and/or maintain any other suitable information for the processing engine 102 or securities marketplace 140 to perform elements of the methods and systems herein. In some embodiments, the optional database(s) can be queried by one or more components of system 100 (e.g., by the processing engine 102), and specific stored data in the database(s) can be retrieved.

Securities marketplace 140 is a platform configured to facilitate the buying, selling, and trading of IP securities. In some embodiments, the platform is further configured to tokenize, i.e., generate shares of, IP securities. In some embodiments, the platform is further configured to enable clearance and settlement of transfers of IP securities.

FIG. 2A is a diagram illustrating an exemplary computer system 200 with software modules that may execute instructions to perform some of the methods herein relating to tokenization of IP securities. In some embodiments, the modules illustrated are components of the processing engine 102.

Marketplace module 202 functions to maintain a marketplace for securitized IP including a number of users, each associated with an account.

Request module 204 functions to receive a request from an authorized entity to register a security within the marketplace, the security being associated with one or more specified IP assets.

Escrow account module 206 functions to receive an escrow account for the security, and transfer, at specified intervals, gross revenue pertaining to the security to the escrow account.

Contract module 208 functions to execute a contract stipulating that all gross revenue from the IP assets is to be paid into the escrow account for distribution to one or more security owners.

Shares module 210 functions to generate a number of shares for the security for exchange within the marketplace.

Listing module 212 functions to publicly list, within the marketplace, one or more of the shares for the security based on a request from the authorized entity to list the shares.

The above modules and their functions will be described in further detail in relation to an exemplary method below.

FIG. 2B is a flow chart illustrating an exemplary method that may be performed in some embodiments relating to tokenization of IP securities.

At step 220, the system maintains a marketplace for securitized IP (abbreviated hereinafter to “securities marketplace”).

The securities marketplace has a number of users, and each user is associated with an account. In some embodiments, each user may be associated with one or more accounts. In some embodiments, users may each be one or more of, e.g., an original owner of one or more IP assets (i.e., an IP owner), an originator of an IP security which is associated with one or more IP assets, an original owner of one or more shares of an IP security, a purchaser of one or more shares of an IP security (i.e., a shareholder for an IP security), a prospective purchaser, seller, or trader of shares of an IP security, or any other potential user of the securities marketplace seeking to make use of its functions.

In some embodiments, the securities marketplace is maintained by an entity (the “maintaining entity”) which may be one or more of a developer, host, provider, and/or publisher of the securities marketplace. The securities marketplace may be hosted on one or more servers, and may be communicatively connected to one or more local or remote databases or websites acting as repositories of data, information, and/or assets.

In some embodiments, an account associated with a user may hold a balance. A balance may be any amount (including a zero amount or, in some embodiments, a negative amount) and may represent an amount of economic value tied to a specific currency. In some embodiments, a user account may be associated with one or more holdings, which refers to shares of securities within the marketplace which are currently held by the user. In various embodiments, a user account may additionally hold, e.g., one or more user preferences, user settings choices, information about the user's device(s), or any other information related to a user or the user's account which may be relevant to the securities marketplace.

At step 230, the system receives a request from an authorized entity to register a security within the marketplace, the security being associated with one or more specified IP assets. An IP asset, as used herein, may represent one or more of: a granted patent, a pending non-provisional patent application, a provisional patent application, a peer-reviewed article (such as an article in a scientific journal), a prototype, a product in one of a variety of stages of development or in a finished state, a registered copyright or trademark, a technical document or description, a book, a software program, a piece of art, a piece of recorded music, a video, or any other document, writing, legal instrument, software, or other expression which may represent “intellectual property” in some way or form.

In various embodiments, an authorized entity may be any party who is authorized and entitled to act with respect to registration of an IP security. In some embodiments, an authorized entity may also be a party who is authorized to act on behalf of other persons (i.e., shareholders) who are entitled to act with respect to an IP security.

In some embodiments, the request to register the security is received electronically. In some embodiments, the request is submitted via a user interface displayed on a client device for the securities marketplace which provides an electronic form to be filled out and submitted. In other embodiments, the request may be submitted via one or more of electronic mail, electronic message(s), a non-electronic physical form (e.g., a paper form) which can be submitted via physical mail, or any other suitable electronic or non-electronic forms of transmitting the request.

The request to register the security includes information pertaining to the security. This information includes at least a listing of the one or more IP assets which correspond to the IP security. The information may be any information that is associated with the authorized entity submitting the request, information relating to one or more user accounts and/or client devices associated with the authorized entity submitting the request, a quantity of shares requested to be generated, a contract to be executed as a prerequisite to a trade of the security within the marketplace, or any other relevant information for generating an IP security for listing within the marketplace.

In some embodiments, the system reviews the one or more specified IP assets associated with the security for approval to be listed within the marketplace. In various embodiments, the review may be performed in, e.g., a manual fashion, automated fashion, or semi-automated fashion. In some embodiments, a review will include some analysis or processing of content (such as documents) which constitutes the one of more IP assets which are relevant for the security. For example, a review may determine whether a submitted article has been published in a peer-reviewed publication or not; whether a patent application's current status is pending, allowed, or abandoned; or whether the content of the document has been determined to refer to ideas widely considered scientifically impossible, such as ideas which would violate the laws of thermodynamics. In various embodiments, a review may additionally or alternatively be based at least partly on original authorship (or lack thereof), legality of the idea, expertise of the author(s) in relevant fields, market demand, profit potential, and/or any other relevant criteria or factor.

In some embodiments, the system determines a nominal fair value for the security, the nominal fair value representing a value for purchasing a reserve of shares of the security in order to provide liquidity to the market. In some embodiments, this determination is performed via one or more artificial intelligence (hereinafter “AI”) models. In various embodiments, AI models may include, e.g., one or more: convolutional neural networks, deep neural networks, deep learning techniques, machine learning techniques, or any other relevant techniques, networks, or systems for facilitating AI-based determinations, predictions, or classifications.

In order for the securities marketplace to provide consistent liquidity and prevent price manipulation, orders within the marketplace must be considered cleared by the maintaining entity of the marketplace. In some embodiments, it may be the case in practice that most or all of the orders will be filled by the operator as well. A desire or requirement to minimize administrative costs, including the cost of issuing new securities as well as the cost of making the market, in turn requires an automatic or semi-automatic “valuation mechanism” within the system to stabilize prices. In some embodiments, such a valuation mechanism within the system calculates a nominal fair value for each security in order to buy a reserve of securities and provide liquidity to the market as a whole.

When a new security is listed, in practice, it is often very difficult or impossible to obtain macro-level performance information for a security that corresponds to the value of intellectual property assets. Often, the only obtaining information may be information about the entity who requested the security to be listed. Thus, an AI model, such as a neural network model, may be trained on such data in order to support a pricing model for new securities listed in the marketplace. When no one offers shares for sale, the market maker will typically set the fair value price of the security. This AI-facilitated pricing of new securities will additionally prohibit users from, for example, purchasing very large amounts of shares of the new security for a low price, convincing other users that the security is about to drastically increase in price, then profiting off of the situation they've created. By the valuation mechanism creating a more balanced, long-tail-oriented price for a new security, a safer market is enabled.

In some embodiments, the inputs to the one or more AI models can include one or more of: the authorized entity associated with registering the security; one or more employees of the authorized entity who worked on the one or more IP assets associated with the security, proportional to compensation; one or more security owners (e.g., investors and other shareholders); one or more exchange-traded funds (“ETFs”) which contain the security, proportional to trading volume of the security and/or size of the ETF; and/or buy-side and sell-side pressure and volume for the security. ETFs are funds that trade within the marketplace, wherein an investor in the ETF acquires a bundle of assets—for example, a collection of tens or hundreds of different IP securities—which can then be bought or sold like individual IP securities within the marketplace. In some embodiments, actual price data from buyers and sellers may be included as an input to the AI models once it is available. In some embodiments, the outputs of the one or more AI models comprise one or more of: a valuation model for an arbitrary security; and/or volume and volatility predictions for all securities within the marketplace. In some embodiments, the training dataset for the AI model is unsupervised in nature, to avoid the ability for humans to tweak the model and introduce the possibilities of corruption or insider trading.

In some embodiments, because the price of an illiquid security may otherwise be relatively easy to manipulate, trading illiquid securities is only permitted by the marketplace via ETFs when the ETF itself is liquid. To some degree, for example, it may be possible to affect the price of one security by bundling it in a popular ETF with a more popular security, even if it doesn't necessarily belong (for example, adding shares in a small-budget, independent film to an ETF called “mega-cap technologies”). The main disincentive to this strategy is that it would harm the reputation of the ETF owner, but the potential for profit is minimized by the long training time of the pricing model. Also, any deceptive attempt to provide liquidity to an illiquid security will quickly be mitigated by allowing trading of the individual security.

To a lesser extent, it may be possible to influence the price of a security by issuing unfillable orders for it in order to affect the market-making price model. In some embodiments, order data is therefore deliberately weighted according to how likely the order was to be filled during model training in order to mitigate this risk.

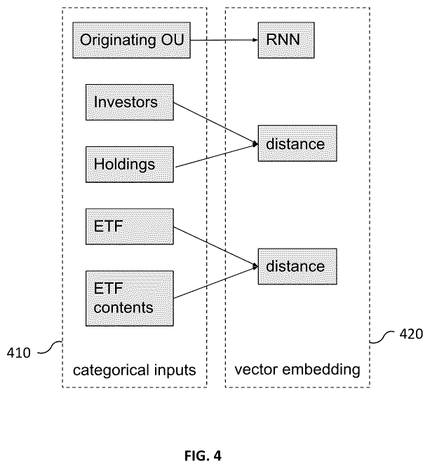

In some embodiments, the categorical inputs to the AI model(s) (e.g., authorized entity, employee, investor, etc.) require a vector embedding as a preprocessing step. An example of such a vector embedding is discussed in detail with respect to FIG. 4.

FIG. 4 is a diagram illustrating one example embodiment of a dependency graph for categorical feature embedding in an automated valuation mechanism, in accordance with some embodiments. Within the illustrated embodiment, categorical inputs 410 are shown on the left, while vector embedding 420 is shown on the right. The categorial inputs 410 shown on the left include the originating organizational unit (“OU”), i.e., the authorized entity, investors, holdings, ETF, and ETF contents. In this example embodiment, the authorized entity input is fed into a Recurrent Neural Network (“RNN”), the investors and holdings inputs are fed into a distance function, and the ETF and ETF contents are fed into the distance function.

In some embodiments, the distance function in the example embodiment represents the Cartesian distance between points in sparse matrices of:

$$( investor ) \times ( security ) = ( quantity )$$

$$( ETF ) \times ( security ) = ( quantity )$$

The ETF embedding is normalized by ETF size. In some embodiments, more sophisticated embeddings, such as, e.g., word2vec or group2vec may be possible. In various embodiments, other possible approaches or strategies for sophisticated embeddings may include one or more of, e.g.: a heuristics-based approach, i.e., trial and error with arbitrary, manually-defined rules; logistic, linear, or multilinear regression; singular value decomposition; kernel method(s); principal component analysis; perceptrons; support vector machines; deep neural networks; a pipeline composed of multiple of these approaches; a simulated marketplace of multiple individual trading strategies; construction of individual models for individual stocks or ETFs using any of these approaches independently; a decision tree; a decision forest; searching the space of all possible algorithms using a Monte Carlo Markov Chain (“MCMC”) or genetic algorithm; or any other suitable or relevant approach.

Such approaches relate to predicting the price of a security directly. However, in practice, the market price of a security depends upon the behaviors of traders, and is not an intrinsic property of the security. Therefore, in some embodiments, it may be more productive to construct a simulation of market dynamics with many agents, i.e., simulated traders, obeying their own independent strategies—for example, one or more of the approaches above, or simply acting at random—then match the performance of that simulation to the past performance of the market in order to determine a market price.

In some other embodiments, however, the distance function may be used as a simpler and more universal approach to computing a vector for each category (i.e., investor or ETF) in terms of its similarity to other categories of the same input. The authorized entity requires a vector embedding which can handle a tree with an arbitrary number of levels in its hierarchy, such as the RNN in the example embodiment.

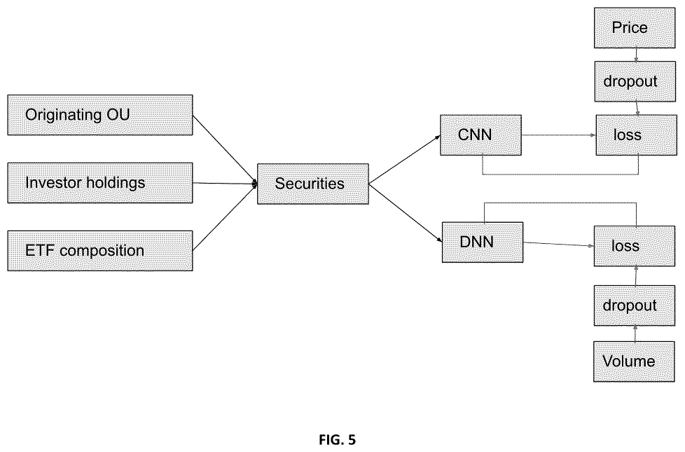

In some embodiments, the vector-embedded categorical inputs are then concatenated into a single “securities” input and fed into the trading (i.e., market-making) model, as illustrated in FIG. 5.

FIG. 5 is a diagram illustrating one example embodiment of an artificial intelligence (hereinafter “AI”) model diagram with prediction flow for an automated valuation mechanism, in accordance with some embodiments. The example embodiment specifically illustrates a deep learning model, with prediction flow on the left (illustrated with the solid arrows) and training flow on the right (illustrated with the dashed arrows). Within the prediction flow, the authorized entity, investor holdings, and ETF composition are fed into securities, which feed into a convolutional neural network (“CNN”) and deep neural network (“DNN”). In some embodiments, the investor holdings and ETF composition inputs are time-dependent, i.e., quantized by a unit of time (such as, for example, 1 second) while the authorized entity input is static. The CNN in turn produces a price, which includes both the buy and sell prices, i.e., the “spread” for the security. “Dropout” is applied in lieu of removing a portion of the input dataset for validation in order to prevent overfitting. Loss is then computed. The DNN, meanwhile, produces a volume, which represents the total volume of all orders weighted by reciprocal difference from the market price, rather than only completed transactions, i.e., even orders which were not filled are included. The price function is implemented as a CNN because in practice (i.e., when used to price a security in real time) the CNN will not have access to future prices; instead, the CNN is configured to reproduce exactly the past pricing dynamics of the market. The volume function, by contrast, is specifically configured to behave differently in the future than in the past, by filling more orders and therefore increasing the trading volume of the market as a whole. This is why it is implemented as a fully connected (i.e., deep) neural network.

In various embodiments, the function of the model is to maximize the liquidity of each security by one or more of: 1) maintaining a small number of shares of each security for sale at any given time when the market is open; 2) making the price of each security even when there are no open orders for it; and 3) maximizing the trading volume of the market as a whole. The marketplace can profit from the “spread” between buy and sell prices, but is subject to risk if the value of its balance sheet suddenly changes. The model outputs must be kept secret in order to prevent market manipulation, but the inputs must be public, where “public” as used herein means accessible by all market participants, i.e., all users within the marketplace, in order to ensure standards of equity and fairness within the market.

In some embodiments, because the price of an illiquid security may not be difficult to manipulate in some cases, trading illiquid securities is only permitted via ETFs of many individual securities, when the ETF itself is liquid. In some embodiments, some default ETFs will be defined by the market operator (e.g., “all securities”, “newer than one month”, “zero revenue”, “revenue-producing”, etc.), but qualified investors will be able to define their own ETFs as well, so long as each ETF in aggregate meets the liquidity requirements of the market. In various embodiments, these ETFs can be defined statically (e.g., by compiling a weighted list of securities that fit a subjective category such as, e.g., “software”, “finance”, or “space exploration”) or dynamically via smart contract, to include all securities which meet some programmatic selection criteria (e.g., “revenue growth is greater than 5% per month”). In some embodiments, traders may also define smart contracts to behave in more complex ways, e.g., to define an options contract with a specific date and strike price, or instruments to hedge risk for compensated employees who are unable to liquidate large positions in a single security.

Returning to FIG. 2B, at step 240, the system receives an escrow account for the security. In some embodiments, a new escrow account is generated for the purpose of being used in relation to the security. In some embodiments, the escrow account is used specifically for the purpose of paying out dividends to shareholders at specified intervals, where the dividends are gross revenue received in relation to the security. In some embodiments, an existing escrow account is received from a user or authorized entity seeking to register the security. In some embodiments, the system will perform a check to ensure that the escrow account satisfies all requirements for holding funds relating to marketplace orders for the security. The idea is that any funds that are received by a seller in exchange for shares are to be deposited into the escrow account, with only limited, condition-specific ability by the seller to withdraw funds from the escrow account.

At step 250, the system executes a contract stipulating that all gross revenue from the IP assets is to be paid into the escrow account for distribution to one or more security owners. In some embodiments, the contract is a smart contract. In some cases a smart contract may be preferable in order to avoid the need for the maintaining entity and/or users of the marketplace to maintain and keep track of individual contracts as well as the relationships of the parties to the contracts. Smart contracts may also provide the benefit of transparent, consistent enforcement of stipulations. If an individual contributor to a piece of IP, such as a sole inventor named in a patent application, is provided with shares in the security for that IP, then that contributor may reap the benefits of the valuation of the IP increasing over time in a consistent and transparent way, facilitated by the smart contract for the security.

In some embodiments, the contract further stipulates that the authorized entity agrees to not enter into any other contract with respect to distribution of gross revenue from the IP assets. That is, the contract to be executed is exclusive with respect to stipulating how gross revenue from the IP assets is distributed to shareholders of the security. In some embodiments, the contract stipulates that shareholders of the security no longer have rights to sell shares of the security via any other means, such as, e.g., a non-tokenized royalty contract. In some embodiments, the contract stipulates that shareholders collectively are owners of the security. In such a case, it may be important for the authorized entity, such as a corporation which owns the IP rights to the IP assets, to have a majority stake and ownership in the shares, in order for a majority of the gross revenue from the IP to accrue to the authorized entity as might be expected.

At step 260, the system generates a number of shares for the security for exchange within the marketplace. In some embodiments, the process of generating the shares includes the creation of a new IP security within the marketplace. In some embodiments, this IP security is a data object that is created for use within the backend of the securities marketplace.

In some embodiments, generating the plurality of shares for the security includes generating a positive integer number of shares for the security such that the shares of the security cannot be fractionalized. In some embodiments, the quantity of the plurality of shares for the security cannot be modified once the shares have been generated. In some embodiments, the system receives a request to modify the total number of shares for the security within the marketplace, and then rejects the request. For example, the number of shares created may be 10 million shares. This number cannot be changed, and any transaction which alters the total number of shares on the exchange must be rejected.

In some embodiments, the process of generating the shares for the security includes verifying the accuracy of information associated with the request to register the shares, in order to determine the validity of the associated IP assets or other associated details. In some embodiments, verifying the accuracy of the information includes cross-referencing the information submitted with the request with data from one or more databases or websites. In various embodiments, such databases or websites may be maintained as part of or external to the securities marketplace, and may be maintained by the maintaining entity of the securities marketplace or another third-party entity.

In some embodiments, verifying the accuracy of the record information includes determining that the associated IP assets have not been previously associated with any securities within the marketplace. That is, if the information submitted with the request is identical to or overlapping with the associated IP assets of one or more previously generated securities or shares, then the request will be denied.

At step 270, the system publicly lists, within the marketplace, one or more of the shares for the security based on a request from the authorized entity to list the shares.

In some embodiments, a trading section of the securities marketplace is displayed for a user. In some embodiments, the user may see a user interface for the marketplace displayed via a client device, and the trading section is displayed within the user interface. In various embodiments, the trading section can include, for example, a trading chart including price and volume values for IP securities listed within the exchange. The system may publicly list the newly created shares for the newly registered security within this trading section. In some embodiments, an order book can be displayed showing current orders available within the exchange, and an order entry section allowing the user to submit trading requests, including purchase requests (i.e., buy order requests) in the case of a prospective buyer of shares, or sale requests (i.e., sell order requests) in the case of a prospective seller of shares. In various embodiments, a trading request may be one or more of, e.g., a market order, a limit order, a stop order, or a stop-limit order. For example, a sell limit order may involve a request to sell at least a subset of shares at a specified selling price or higher.

In some embodiments, the shares for the security are listed within the marketplace along with one or more pieces of information pertaining to the security. In some embodiments, the information includes one or more of: type of IP asset associated with the shares, reputation of the issuer of the shares, and/or skill of the compensated employees associated with the IP asset. In some embodiments, the information is publicly viewable by any user of the marketplace.

At step 280, the system deposits gross revenue pertaining to the security into the escrow account. In some embodiments, the system deposits this gross revenue at specified intervals. The intervals may be specified in the contract, or specified by some other mechanism within the system. In some embodiments, this may be specified by default, or as specified by one or more parties to the contract and agreed to by all parties to the contract.

In some embodiments, the system may be configured to distribute, at a specified time interval, funds from the escrow account, i.e., the gross revenue that has been deposited into the escrow account, as dividends that are divided among the security owners, i.e., shareholders. In some embodiments, the specified time may be specified within the contract (e.g., smart contract) and implemented within the marketplace. The implementation may be accomplished automatically (such as in the case of an executed smart contract), manually, or semi-automatically. In some embodiments, the contract additionally stipulates one or more terms which govern how the funds are to be divided up and/or distributed to the shareholders.

In some embodiments, the authorized entity retains a majority stake in the security as a security owner. In various embodiments, this may be stipulated within the contract or executed automatically. For example, in some embodiments, the authorized entity may have a majority stake in shares distributed to it as part of the registration of the security or creation of the shares, or an executed smart contract may lead to the authorized entity having a majority stake in shares distributed to them. In some embodiments, the authorized entity must be sure to manually purchase a majority amount of shares if they wish to be a majority stakeholder, as no automated mechanism is put in place for it to happen otherwise.

In some embodiments, the system receives a request to distribute one or more of the shares for the security to one or more compensated employees of the authorized entity, and then distributes the shares to the compensated employees via the marketplace. In some embodiments, this is stipulated explicitly within the smart contract and implemented automatically as part of the smart contract being executed. In some embodiments, the distribution of shares to employees is performed during the registration of the security, creation of shares, or public listing of the shares within the marketplace. This distribution of employees may be useful in scenarios such as when an authorized entity wishes its employees who are inventors to have a certain amount of stake in the inventions (e.g., patent applications which have been filed or patents which have been granted) which they have materially contributed to.

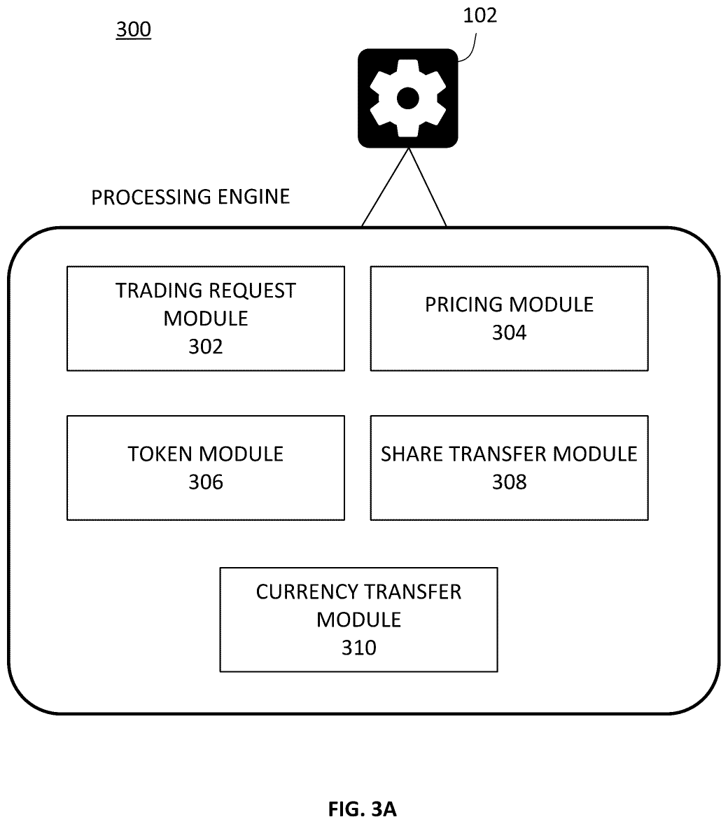

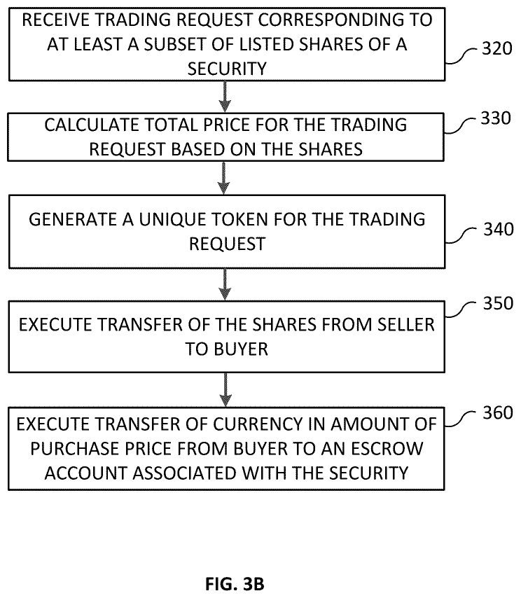

FIG. 3A is a diagram illustrating an exemplary computer system 300 with software modules that may execute instructions to perform some of the methods herein relating to trading of IP securities within a marketplace. In some embodiments, the modules illustrated are components of the processing engine 102.

Trading request module 302 functions to receive a trading request corresponding to at least a subset of listed shares of a security associated with one or more IP assets, where the trading request represents one of a purchase request or a sale request.

Pricing module 304 functions to calculate a total price for the trading request based on the subset of shares in the trading request.

Token module 306 functions to generate a unique token for the trading request.

Share transfer module 308 functions to execute a transfer of the shares from a seller of the shares to a clearinghouse application.

Currency transfer module 310 functions to execute a transfer of currency in the amount of the purchase price from a buyer to the clearinghouse application.

Clearinghouse module 312 functions to execute a transfer of the shares from the clearinghouse application to the buyer and a transfer of the currency from the clearinghouse application to the seller.

The above modules and their functions will be described in further detail in relation to an exemplary method below.

FIG. 3B is a flow chart illustrating an exemplary method that may be performed in some embodiments relating to trading of IP securities within a marketplace.

At step 320, the system receives a trading request corresponding to at least a subset of listed shares of a security associated with one or more IP assets, where the trading request represents one of a purchase request or a sale request.

In some embodiments, the trading request is received electronically. In some embodiments, the trading request is submitted via a user interface of the securities marketplace which provides an electronic form to be filled out and submitted. In other embodiments, the trading request may be submitted via one or more of electronic mail, electronic message(s), phone communication, or any other suitable electronic or non-electronic forms of transmitting the request.

In some embodiments, the trading request may include a specification of whether to buy or sell shares, the number of shares to buy or sell, and a buying or selling price for the shares. The order will then be submitted by the user, and if approved by system requirements, will appear within the exchange (e.g., on the order books).

At step 330, the system calculates a total price for the trading request based on the subset of shares in the trading request. In some embodiments, where each share of the chosen security has a listed price within the marketplace, the system adds up the price for the desired number of shares for that security. In some embodiments, the system uses an automatic valuation mechanism to set or adjust one or more prices after the trading request has been submitted. Upon the system displaying the set or adjusted price, the requesting user may then have the option to proceed with the set or adjusted price for the order, or cancel the trading request.

In some embodiments, the system matches the trading request with a complementary purchase request or sale request. In some embodiments, if a sell order on the books (submitted by a seller) matches with a buy order on the books (submitted by a buyer), then the trading request of the sale matches with the complementary purchase request, and the orders execute for additional processing. In other embodiments, the trading request may proceed without any matching being necessary, as the trading request is submitted only for shares which are currently listed within the marketplace and selected by the requester.

In some embodiments, the system determines that the trading request pertains to a trade that would lead to a change in the price of the security beyond a price change threshold; and based on the determination, the system rejects the trading request. This rejection may be performed when the system determines that a sufficiently large enough trade would affect the liquidity pool or specified liquidity requirements of the marketplace. The price change threshold may be specified and configurable by the maintaining entity for the marketplace, an AI model for calculating price change thresholds per security, or some other similar method.

In some embodiments, the system determines that the trading request constitutes a request to lend shares to a borrower; and based on the determination, rejects the trading request. In some cases, the system may prohibit lending of shares. This prohibition may be put in place, for example, because lending shares may potentially be used for price manipulation by creating a balance sheet of all outstanding shares which is larger than the market capitalization of the security.

In some embodiments, all transactions must be explicitly authorized by the buyer, seller, and exchange before the transaction is considered valid and is approved to proceed by the marketplace. Such authorizations may occur via one or more user interface elements displayed to client devices associated with the buyer, seller, and/or maintaining entity of the marketplace. In some embodiments, institutional market participants have the option to not hold clients responsible for unauthorized transactions.

At step 340, the system generates a unique token for the trading request. In some embodiments, the unique token is represented as a unique transaction identification (hereinafter “ID”) number.

In some embodiments, the unique token for the trading request is associated with at least one of: the user account of a buyer within the marketplace, a purchase price for the trading request, and one or more sources of the purchased shares. In some embodiments, the one or more sources of the purchased shares are each associated with unique tokens different from the unique token associated with the trading request.

At step 350, the system executes a transfer of the shares from a seller of the shares to a clearinghouse application. In some embodiments, the system executes the transfer by transferring the requisite number of shares from a user account associated with a seller to a clearinghouse application. In some embodiments, the clearinghouse application is configured to hold the shares of the security within a secure account, repository, wallet, or other secure manner for holding shares of a security within the marketplace.

In some embodiments, the clearinghouse application is an application within the system, such as an application configured to run on a client device, such as, e.g., a client device associated with one or more agents of the maintaining entity of the marketplace. In some embodiments, the clearinghouse application may be an application which can execute on a blockchain, such as, e.g., a blockchain on which the marketplace also functions. The clearinghouse application may take the form of a smart contract, for example. In some embodiments, the clearinghouse application has permission to receive every seller's shares and every buyer's currency, and the clearinghouse application further has permission to transfer currency directly to sellers and shares directly to buyers. In some embodiments, the clearinghouse application only executes such transfers once it clears or rejects a trade. In some embodiments, this allows the possibility for users to, e.g., report a fraudulent trade before it clears, or to reject trades made by a user who finds a way to evade governance rules.

In some embodiments, the seller is a first account associated with the transfer, while a second account is a buyer that is also associated with the transfer. In some embodiments, the seller and buyer, and their respective accounts, are identified during an earlier step involving matching a buy order with a sell order. In other embodiments, the seller account is the one which listed the shares for sale on the marketplace, and the buyer account is the one which has initiated the transfer request.

At step 360, the system executes a transfer of currency in the amount of the purchase price from a buyer to the clearinghouse application. In some embodiments, this includes settling a purchase order by transferring required funds for the purchase from the account associated with the buyer, to the clearinghouse application. In some embodiments, transfer of the currency involves transferring economic value from the account associated with the buyer to the clearinghouse application. In some embodiments, the clearinghouse application is configured to hold the currency funds within a secure account, repository, wallet, or other secure manner for holding funds.

In various embodiments, the currency accepted by the clearinghouse application may be: only fiat currency; only cryptocurrency; or either fiat or cryptocurrency. In some embodiments, the clearinghouse application may have different such policies associated with it depending on security, authorized entity, or other factor, while in some embodiments, a single policy is globally applied throughout the marketplace, and any currencies which fall outside of the policy lead to the transfer being rejected by the clearinghouse application. In some embodiments where the currency accepted by the clearinghouse application is a cryptocurrency, the purchase price is denominated in the cryptocurrency.

At step 370, the system executes a transfer of shares from the clearinghouse application to the buyer, and executes a transfer of currency from the clearinghouse application to the seller. In some embodiments, this is performed upon receiving approval of the transfer from the clearinghouse application. In some embodiments, the shares are deposited into an account associated with the buyer via a mechanism within the backend of the marketplace which holds and maintains shares and associated information and records for each individual shareholder within the marketplace. Thus, the transferred shares are now on record as being part of the buyer's portfolio. In some embodiments, the currency is deposited into an account associated with the seller via a mechanism for holding and maintaining currency associated with the seller account. In some embodiments, the currency funds may be transferred to a virtual wallet or other repository for holding funds for a user account within the marketplace.

In some embodiments, various aspects of the steps described above can be implemented using blockchain techniques. In some embodiments, valid trading requests which lead to successful transfers of shares (i.e., via step 350 above) and successful transfers of currency (i.e., via step 360 above) are recorded as transactions that compose blocks in the blockchain. In some embodiments, trading activities may be implemented through the transfer of a cryptocurrency from one virtual wallet to another (perhaps in exchange for compensation).

In some embodiments, the system receives a request for a compliance report for the completed trade based on the trading request. Upon receiving the request for the compliance report, the system generates a report of the cost basis of the shares within the trading request based on the information associated with the trading request, and then sends the report to one or more regulatory agencies for compliance purposes.

In some embodiments, details of the trade associated with the trading request are publicly accessible to at least all users within the exchange who are listed as traders. Details may include, for example, the total purchase price, identifying information for the buyer, identifying information for the seller, the security being traded, number of shares transferred, and more. In some embodiments, the system writes details of the trade to a blockchain as a block representing a discrete transaction, where the blockchain is accessible to at least all users within the exchange who are listed as traders.

In some embodiments, the system performs a verification check of one or more of the trade details on the blockchain, the trade details including at least the purchase price for the trade and availability of funds associated with the buyer. In some embodiments, the system may mark the verification check as failed based on detecting, during the verification check, evidence of one or more of: fraud, market manipulation, and/or insufficient funds. In some embodiments, performing the verification check comprises receiving a manual, or at least semi-manual, approval for the trade if the purchase price for the trade exceeds a specified threshold price for manual approval.

In some embodiments, fault tolerance techniques may be implemented with respect to the blockchain. In some embodiments, each transaction is broadcast to all nodes which host all affected capitalization tables. If any node reports a transaction conflict (such as, e.g., due to a concurrent transaction already in process), all nodes must reject the transaction. Otherwise, if, for example, greater than or equal to 50% of nodes report an error, all nodes must reject the transaction, or if less than 50% of nodes report an error (i.e., the transaction is rejected), they are removed from the cluster. This architecture ensures that over 50% of nodes will always have a consistent transaction history which can be used to resolve any disparity or dispute. In some embodiments, these percentages may be replaced with other percentages which suit specific systems and implementations better.

In some embodiments, the system executes a cryptographic signing of the trade associated with the trading request, the cryptographic signing being executed using a private key associated with an account of the buyer. The system then verifies that the trade associated with the trading request has been cryptographically signed, the verification being performed using a public key associated with the account of the seller.

In some embodiments, the system receives, from the seller, a request to withdraw at least a subset of the funds in the escrow account. In response, the system can then withdraw, based on the withdrawal request, at least a subset of the funds in the escrow account to a wallet associated with the seller. In some embodiments, the request to withdraw may be denied if one or more withdrawal conditions are not satisfied. In some embodiments, withdrawal conditions may include conditions relating to whether a liquidity pool for the marketplace would be determined to be negatively affected by the withdrawal to a sufficient extent. In some embodiments, this withdrawal is performed upon verification that one or more of such liquidity pool conditions are satisfied. In some embodiments, withdrawal conditions which may be satisfied can include one or more of: funds needing to be withdrawn for litigation, and/or shares being exchangeable for currency.

In some embodiments, an example of operations of the system is further described as follows:
1. An issuer, via one or more servers, provides a record detailing their IP asset to be tokenized and provides supplementary configuration information such as a bank account or cryptographic wallet address from which revenues will be distributed to owners (token holders)
2. The issuer cryptographically signs a smart contract agreeing to deposit all revenues generated by the asset in the configured account/wallet and distribute them pro-rata according to a specific schedule (e.g. quarterly), and agreeing that only a specific set of market-makers approved by the exchange will be allowed to execute trades which transfer ownership of shares of the securitized IP asset
3. A machine learning model trained on similar data uses the provided record to infer a set of portfolio categories which will benefit from including the asset Optionally, this set of categories may include those defined by individual traders or portfolio holders
4. A securities exchange, via one or more servers, lists the asset for trading (i.e. tokenizes the asset), but rejects any order to buy or sell shares directly, allowing trading only via bundled derivatives since there is insufficient information for the market to assign a price via direct trading
5. Market-makers via one or more servers, update their holdings of bundled securities to include the new asset, allowing indirect trading. Optionally, market-makers require a clearinghouse to approve trades. Optionally, this clearinghouse uses a machine learning model to identify which trades are particularly suspect for fraud, either of the identity of a counterparty or the intent of the trade to manipulate the market pricing mechanism in favor of the trader.
6. A machine learning model analyzes these indirect trades to determine when the price of the asset is sufficiently informative to the price of the categorical bundles that the market will be able to assign a price directly (i.e. when the price differential of the bundles with and without the new asset is consistently positive).
7. When this threshold is reached, market-makers update their holdings to include individual shares of the new asset, allowing direct trading. Optionally, this step may require explicit manual approval from the issuer and some or all market-makers.
8. If the market later fails to price the security, i.e. if the discrete price information falls below the threshold of step 6, market-makers will freeze direct trading but may still purchase shares from existing shareholders in order to balance the holdings of categorical bundles Optionally, the exchange may allow “negative prices,” i.e. allow shareholders to pay to clear their portfolio for administrative purposes or allow issuers to buy back shares which no longer have a clear market value.

In this example, the market dynamics here are dictated by two closely related but distinct basic parameters, price (P) and information (I). This is distinct from securities markets in operation today, which explicitly acknowledge only one of these (P) and leave market participants (traders, asset managers, market-makers, etc.) to treat the I parameter, however, they feel may be profitable. This is why it's currently impractical to list a new security before being very certain that it will have a large trading volume, i.e. why only big companies can go public, because otherwise the stock exchange would just be full of penny-stock scams. The systems and methods described herein provide a technical implementation that includes specific rules not only regarding price but also information. The technical innovation which makes this possible is one of distributed market governance. All trades have to be executed by a market maker, via one or more servers, “licensed” by the exchange via smart contract and this license requires that market makers maintain the same set of governance rules published by the exchange operator, particularly and especially the listing threshold of step 6. This is effectively a distributed app (dApp) distributed via a blockchain which includes a machine learning model in its definition, i.e. something that can be verified by a cryptographic hash and a distributed consensus protocol like Paxos. Without these cryptographic checks in place, the market would be inoperable because market participants would be free to make up their own rules about how to deal with the implicit I parameter (as they are on, say, the NYSE or Nasdaq today).

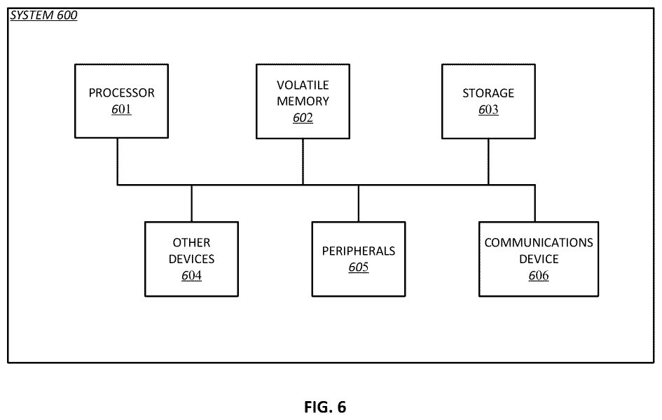

FIG. 6 is a diagram illustrating an exemplary computer that may perform processing in some embodiments. Exemplary computer 600 may perform operations consistent with some embodiments. The architecture of computer 600 is exemplary. Computers can be implemented in a variety of other ways. A wide variety of computers can be used in accordance with the embodiments herein.

Processor 601 may perform computing functions such as running computer programs. The volatile memory 602 may provide temporary storage of data for the processor 601. RAM is one kind of volatile memory. Volatile memory typically requires power to maintain its stored information. Storage 603 provides computer storage for data, instructions, and/or arbitrary information. Non-volatile memory, which can preserve data even when not powered and including disks and flash memory, is an example of storage. Storage 603 may be organized as a file system, database, or in other ways. Data, instructions, and information may be loaded from storage 603 into volatile memory 602 for processing by the processor 601.

The computer 600 may include peripherals 605. Peripherals 605 may include input peripherals such as a keyboard, mouse, trackball, video camera, microphone, and other input devices. Peripherals 605 may also include output devices such as a display. Peripherals 605 may include removable media devices such as CD-R and DVD-R recorders/players. Communications device 606 may connect the computer 100 to an external medium. For example, communications device 606 may take the form of a network adapter that provides communications to a network. A computer 600 may also include a variety of other devices 604. The various components of the computer 600 may be connected by a connection medium such as a bus, crossbar, or network.

It will be appreciated that the present disclosure may include any one and up to all of the following examples.

Example 1. A method, comprising the operations of: training a machine learning model to perform a value determination function pertaining to electronic documents or records, wherein the machine learning model is trained on a plurality of different types of electronic documents or records; receiving, by a first group of one or more servers, a first electronic request from a first computing device relating to a first electronic document, wherein the request includes a first cryptographic signature signed with a first private key, a first data package associated with the electronic request, the first data package including a first public key value for a first public key, a first numeric value and a first document type value, wherein the first public key is paired with the first private key; determining, using the first public key value, that the first electronic request has been cryptographically signed; and if the first electronic request has been determined to have been cryptographically signed then: generating a first unique token comprising a first unique transaction identifier associated with the first electronic request; causing a first update to the blockchain wherein the blockchain is updated with data from the first data package and the first unique token, wherein the blockchain decrements a data value of the first electronic document based on the first numeric value; determining, via the trained machine learning model, a first value parameter, based on input of the first numeric value and the first document type value; and transmitting, to the first computing device, an indication of the first update to the blockchain and the first value parameter.

Example 2. The method of Example 1, further comprising the operations of: receiving, by the first group of one or more servers, a second electronic request from a first computing device relating to the first electronic document, wherein the second request includes a second cryptographic signature signed with a second private key, a second data package associated with the second electronic request, the first data package including a second public key value, a second numeric value and a second document type value, wherein the second private key is paired with the second public key value; determining, using the second public key value, that the second electronic request has been cryptographically signed; and if the second electronic request has been determined to have been cryptographically signed then: generating a second unique token comprising a second unique transaction identifier associated with the second electronic request; causing a second update to the blockchain wherein the blockchain is updated with data from the second data package and the second unique token, wherein the blockchain decrements a data value of the electronic document based on the numeric value of the second data package; determining, via the trained machine learning model, a second value parameter, based on input of the second numeric value and the second document type value of the second data package; and transmitting, to the first computing device, an indication of the second update to the blockchain and the second value parameter.

Example 3. The method of any one of Examples 1-2, further comprising the operations of: receiving, by the first group of one or more servers, a third electronic request from a second computing device relating to the second electronic document, wherein the third electronic request includes a third cryptographic signature signed with a third private key, a third data package, the third data package including a third public key value for a third public key, a third numeric value and a second document type a value, wherein the third public key is paired with the third private key, and wherein the second electronic document type value being different than the first electronic document type value; determining that the third electronic request has been cryptographically signed using the third public key value; and receiving, by the first group of one or more servers, a third electronic request from a second computing device relating to a second electronic document, wherein the third request includes a third cryptographic signature signed with a third private key, a third data package associated with the third electronic request, the third data package including a third public key value for a third public key, a third numeric value and a third document type value, wherein the third public key is paired with the third private key; determining, using the third public key value, that the third electronic request has been cryptographically signed; and if the third electronic request has been determined to have been cryptographically signed then: generating a third unique token comprising a third unique transaction identifier associated with the third electronic request; causing an update to the blockchain wherein the blockchain is updated with data from the third data package and the third unique token, wherein the blockchain decrements a data value of the second electronic document based on the third numeric value of the third data package; determining, via the trained machine learning model, a third value parameter, based on input of the third numeric value and the third document type of the third data package; and transmitting, to the second computing device, an indication of the update to the blockchain and the third value parameter.

4. The method of any one of Examples 1-3, further comprising the operations of: wherein generating the first unique token comprises: generating a first hash-value based, in part, on the first public key value; wherein generating the second unique token comprises: generating a second hash-value based, in part, on the second public key value.

5. The method of any one of Examples 1-4, further comprising the operations of: decrypting, using the first public key, the first data package, wherein a portion of the first data package was encrypted based on the first private key; and decrypting, using the second public key, the second data package, wherein a portion of the second data package was encrypted based on the second private key.

6. A system comprising one or more processors configured to perform the operations of: training a machine learning model to perform a value determination function pertaining to electronic documents or records, wherein the machine learning model is trained on a plurality of different types of electronic documents or records; receiving, by a first group of one or more servers, a first electronic request from a first computing device relating to a first electronic document, wherein the request includes a first cryptographic signature signed with a first private key, a first data package associated with the electronic request, the first data package including a first public key value for a first public key, a first numeric value and a first document type value, wherein the first public key is paired with the first private key; determining, using the first public key value, that the first electronic request has been cryptographically signed; and if the first electronic request has been determined to have been cryptographically signed then: generating a first unique token comprising a first unique transaction identifier associated with the first electronic request; causing a first update to the blockchain wherein the blockchain is updated with data from the first data package and the first unique token, wherein the blockchain decrements a data value of the first electronic document based on the first numeric value; determining, via the trained machine learning model, a first value parameter, based on input of the first numeric value and the first document type value; and transmitting, to the first computing device, an indication of the first update to the blockchain and the first value parameter.

Example 7. The system of Example 6, further comprising the operations of: receiving, by the first group of one or more servers, a second electronic request from a first computing device relating to the first electronic document, wherein the second request includes a second cryptographic signature signed with a second private key, a second data package associated with the second electronic request, the first data package including a second public key value, a second numeric value and a second document type value, wherein the second private key is paired with the second public key value; determining, using the second public key value, that the second electronic request has been cryptographically signed; and if the second electronic request has been determined to have been cryptographically signed then: generating a second unique token comprising a second unique transaction identifier associated with the second electronic request; causing a second update to the blockchain wherein the blockchain is updated with data from the second data package and the second unique token, wherein the blockchain decrements a data value of the electronic document based on the numeric value of the second data package; determining, via the trained machine learning model, a second value parameter, based on input of the second numeric value and the second document type value of the second data package; and transmitting, to the first computing device, an indication of the second update to the blockchain and the second value parameter.

Example 8. The system of any one of Examples 6-7, further comprising the operations of: receiving, by the first group of one or more servers, a third electronic request from a second computing device relating to the second electronic document, wherein the third electronic request includes a third cryptographic signature signed with a third private key, a third data package, the third data package including a third public key value for a third public key, a third numeric value and a second document type a value, wherein the third public key is paired with the third private key, and wherein the second electronic document type value being different than the first electronic document type value; determining that the third electronic request has been cryptographically signed using the third public key value; and receiving, by the first group of one or more servers, a third electronic request from a second computing device relating to a second electronic document, wherein the third request includes a third cryptographic signature signed with a third private key, a third data package associated with the third electronic request, the third data package including a third public key value for a third public key, a third numeric value and a third document type value, wherein the third public key is paired with the third private key; determining, using the third public key value, that the third electronic request has been cryptographically signed; and if the third electronic request has been determined to have been cryptographically signed then: generating a third unique token comprising a third unique transaction identifier associated with the third electronic request; causing an update to the blockchain wherein the blockchain is updated with data from the third data package and the third unique token, wherein the blockchain decrements a data value of the second electronic document based on the third numeric value of the third data package; determining, via the trained machine learning model, a third value parameter, based on input of the third numeric value and the third document type of the third data package; and transmitting, to the second computing device, an indication of the update to the blockchain and the third value parameter.

Example 9. The system of any one of Examples 6-8, further comprising the operations of: wherein generating the first unique token comprises: generating a first hash-value based, in part, on the first public key value; wherein generating the second unique token comprises: generating a second hash-value based, in part, on the second public key value.

Example 10. The system of any one of Examples 6-9, further comprising the operations of: decrypting, using the first public key, the first data package, wherein a portion of the first data package was encrypted based on the first private key; and decrypting, using the second public key, the second data package, wherein a portion of the second data package was encrypted based on the second private key.

Example 11. A method, comprising: receiving, within a marketplace for securitized intellectual property (IP), the marketplace comprising one or more servers, a trading request corresponding to at least a subset of a plurality of listed shares of a security associated with one or more IP assets, wherein the trading request represents one of a purchase request or a sale request; calculating a total price for the trading request based on the subset of shares in the trading request; and processing the trading request by: generating a unique token for the trading request; executing a transfer of the shares from a seller of the shares to a clearinghouse application; executing a transfer of currency in the amount of the purchase price from a buyer to the clearinghouse application; and executing a transfer of the shares from the clearinghouse application to the buyer and a transfer of the currency from the clearinghouse application to the seller.

Example 12. The method of Example 11, further comprising: receiving a determination from the clearinghouse application that the trading request pertains to a trade that would lead to a change in the price of the security beyond a price change threshold; and based on the determination, rejecting the trading request.

Example 13 The method of any one of Examples 11-12, further comprising: receiving a determination from the clearinghouse application that the trading request constitutes a request to lend shares to a borrower; and based on the determination, rejecting the trading request.

Example 14. The method of any one of Examples 11-13, wherein the unique token comprises a unique transaction identification (ID) number.

Example 15. The method of any one of Examples 11-14, wherein the unique token for the trading request is associated with at least one of: the user account of a buyer within the marketplace, a purchase price for the trading request, and one or more sources of the purchased shares.

Example 16. The method of any one of Examples 11-15, wherein the one or more sources of the purchased shares are each associated with unique tokens different from the unique token associated with the trading request.

Example 17. The method of any one of Examples 11-16, further comprising: receiving a request for a compliance report for the completed trade based on the trading request; and upon receiving the request for the compliance report: generating a report of the cost basis of the shares within the trading request based on the information associated with the trading request, and sending the report to one or more regulatory agencies for compliance purposes.

Example 18. The method of any one of Examples 11-17, wherein the currency accepted by the clearinghouse is a cryptocurrency, and wherein the purchase price is denominated in the cryptocurrency.

Example 19. The method of any one of Examples 11-18, wherein the transfer of the cryptocurrency is performed via a wallet associated with a buyer account.

Example 20. The method of any one of Examples 11-19, further comprising: writing details of the trade to a blockchain as a block representing a discrete transaction, wherein the blockchain is accessible to at least all users within the exchange who are listed as traders.

Example 21. The method of any one of Examples 11-20, further comprising: performing a verification check of one or more of the trade details on the blockchain, the trade details comprising at least the purchase price for the trade and availability of funds associated with the buyer.

Example 22. The method of any one of Examples 11-21, further comprising: marking the verification check as failed based on detecting, during the verification check, evidence of one or more of: fraud, market manipulation, and insufficient funds.

Example 23. The method of any one of Examples 11-22, wherein performing the verification check comprises receiving a manual approval for the trade if the purchase price for the trade exceeds a specified threshold price for manual approval.

Example 24. The method of any one of Examples 11-23, further comprising: depositing, at specified intervals, revenue pertaining to the IP security into an escrow account pertaining to the security.

Example 25. The method of any one of Examples 11-24, further comprising: receiving a request to withdraw at least a subset of the revenue from the escrow account; and withdrawing, based on the withdrawal request, at least a subset of the revenue from the escrow account to a wallet associated with the seller.

Example 26. The method of any one of Examples 11-25, wherein withdrawing the at least subset of revenue from the escrow account is performed upon verification that one or more withdrawal conditions are satisfied.

Example 27. The method of any one of Examples 11-26, wherein the withdrawal conditions comprise one or more of: revenue needing to be withdrawn for litigation purposes, and revenue needing to be paid out to shareholders as dividend payments.

Example 28. The method of any one of Examples 11-27, further comprising: executing a cryptographic signing of the trade associated with the trading request, the cryptographic signing being executed using a private key associated with an account of the buyer; and verifying that the trade associated with the trading request has been cryptographically signed, the verification being performed using a public key associated with the account of the seller.

Example 29. A system comprising one or more processors configured to perform the operations of: receiving, within a marketplace for securitized intellectual property (IP), the marketplace comprising one or more servers, a trading request corresponding to at least a subset of a plurality of listed shares of a security associated with one or more IP assets, wherein the trading request represents one of a purchase request or a sale request; calculating a total price for the trading request based on the subset of shares in the trading request; and processing the trading request by: generating a unique token for the trading request; executing a transfer of the shares from a seller of the shares to a clearinghouse application; executing a transfer of currency in the amount of the purchase price from a buyer to the clearinghouse application; and executing a transfer of the shares from the clearinghouse application to the buyer and a transfer of the currency from the clearinghouse application to the seller.

Example 30. The system of Example 29, further comprising: receiving a determination from the clearinghouse application that the trading request pertains to a trade that would lead to a change in the price of the security beyond a price change threshold; and based on the determination, rejecting the trading request.

Example 31. The system of any one of Examples 29-30, further comprising: receiving a determination from the clearinghouse application that the trading request constitutes a request to lend shares to a borrower; and based on the determination, rejecting the trading request.

Example 32. The system of any one of Examples 29-31, wherein the unique token comprises a unique transaction identification (ID) number.

Example 33. The system of any one of Examples 29-32, wherein the unique token for the trading request is associated with at least one of: the user account of a buyer within the marketplace, a purchase price for the trading request, and one or more sources of the purchased shares.

Example 34. The system of any one of Examples 29-33, wherein the one or more sources of the purchased shares are each associated with unique tokens different from the unique token associated with the trading request.

Example 35. The system of any one of Examples 29-34, further comprising: receiving a request for a compliance report for the completed trade based on the trading request; and upon receiving the request for the compliance report: generating a report of the cost basis of the shares within the trading request based on the information associated with the trading request, and sending the report to one or more regulatory agencies for compliance purposes.

Example 36. The system of any one of Examples 29-35, wherein the currency accepted by the clearinghouse is a cryptocurrency, and wherein the purchase price is denominated in the cryptocurrency.

Example 37. The system of any one of Examples 29-36, wherein the transfer of the cryptocurrency is performed via a wallet associated with a buyer account.

Example 38. The system of any one of Examples 29-37, further comprising: writing details of the trade to a blockchain as a block representing a discrete transaction, wherein the blockchain is accessible to at least all users within the exchange who are listed as traders.

Example 39. The system of any one of Examples 29-38, further comprising: performing a verification check of one or more of the trade details on the blockchain, the trade details comprising at least the purchase price for the trade and availability of funds associated with the buyer.

Example 40. The system of any one of Examples 29-39, further comprising: marking the verification check as failed based on detecting, during the verification check, evidence of one or more of: fraud, market manipulation, and insufficient funds.

Example 41. The system of any one of Examples 29-40, wherein performing the verification check comprises receiving a manual approval for the trade if the purchase price for the trade exceeds a specified threshold price for manual approval.

Example 42. The system of any one of Examples 29-41, further comprising: depositing, at specified intervals, revenue pertaining to the IP security into an escrow account pertaining to the security.

Example 43. The system of any one of Examples 29-42, further comprising: receiving a request to withdraw at least a subset of the revenue from the escrow account; and withdrawing, based on the withdrawal request, at least a subset of the revenue from the escrow account to a wallet associated with the seller.

Example 44. The system of any one of Examples 29-43, wherein withdrawing the at least subset of revenue from the escrow account is performed upon verification that one or more withdrawal conditions are satisfied.

Example 45. The system of any one of Examples 29-44, wherein the withdrawal conditions comprise one or more of: revenue needing to be withdrawn for litigation purposes, and revenue needing to be paid out to shareholders as dividend payments.

Example 46. The system of any one of Examples 29-45, further comprising: executing a cryptographic signing of the trade associated with the trading request, the cryptographic signing being executed using a private key associated with an account of the buyer; and verifying that the trade associated with the trading request has been cryptographically signed, the verification being performed using a public key associated with the account of the seller.

Example 47. A method, comprising: maintaining a marketplace, comprising one or more servers, for securitized intellectual property (IP) comprising a plurality of users, each associated with an account; receiving a request from an authorized entity to register a security within the marketplace, the security being associated with one or more specified IP assets; registering the security within the marketplace, wherein registering comprises: receiving an escrow account for the security, executing a contract stipulating that all gross revenue from the IP assets is to be paid into the escrow account for distribution to one or more security owners, and generating a plurality of shares for the security for exchange within the marketplace; publicly listing, within the marketplace, one or more of the shares for the security based on a request from the authorized entity to list the shares; and depositing, at specified intervals, gross revenue pertaining to the security into the escrow account.

Example 48. The method of Example 47, wherein the IP asset represents one or more of: a patent, a pending patent application, and/or a peer-reviewed article.

Example 49. The method of any one of Examples 47-48, further comprising: distributing, at a specified time interval, funds from the escrow account as dividends that are divided among the security owners.

Example 50. The method of any one of Examples 47-49, wherein the authorized entity retains a majority stake in the security as a security owner.

Example 51. The method of any one of Examples 47-50, wherein the contract is a smart contract.

Example 52. The method of any one of Examples 47-51, wherein the contract further stipulates that the authorized entity agrees not to enter into any other contract with respect to distribution of gross revenue from the IP assets.

Example 53. The method of any one of Examples 47-52, wherein generating the plurality of shares for the security comprises generating a positive integer number of shares for the security such that the shares of the security cannot be fractionalized.

Example 54. The method of any one of Examples 47-53, wherein the quantity of the plurality of shares for the security cannot be modified once the shares have been generated.

Example 55. The method of any one of Examples 47-54, further comprising: receiving a request to modify the total number of shares for the security within the marketplace; and rejecting the request.

Example 56. The method of any one of Examples 47-55, further comprising: receiving a request to distribute one or more of the shares for the security to one or more compensated employees of the authorized entity; and distributing the shares to the compensated employees via the marketplace.

Example 57. The method of any one of Examples 47-56, wherein the plurality of shares for the security are listed within the marketplace along with one or more pieces of information pertaining to the security.

Example 58. The method of any one of Examples 47-57, wherein the information comprises one or more of: type of IP asset associated with the shares, reputation of the issuer of the shares, and skill of the compensated employees associated with the IP asset.

Example 59. The method of any one of Examples 47-58, further comprising: paying, at specified intervals, at least a subset of the revenue in the escrow account to shareholders of the security as dividend payments.

Example 60. The method of any one of Examples 47-59, further comprising: prior to generating the plurality of shares for the security, reviewing the one or more specified IP assets associated with the security for approval to be listed within the marketplace.

Example 61. The method of any one of Examples 47-60, further comprising: determining a nominal fair value for the security, the nominal fair value representing a value for purchasing a reserve of shares of the security in order to provide liquidity to the market.

Example 62. The method of any one of Examples 47-61, wherein the determination is performed via one or more artificial intelligence (AI) models, wherein the inputs to the one or more AI models comprise one or more of: the authorized entity associated with the security, one or more employees of the authorized entity who worked on the one or more IP assets associated with the security, one or more security owners, one or more exchange-traded funds (ETFs) which contain the security, and buy-side and sell-side pressure and volume for the security.

Example 62. The method of any one of Examples 47-61, wherein the outputs of the one or more AI models comprise one or more of: a valuation model for an arbitrary security, and volume and volatility predictions for the securities.

Example 63. A system comprising one or more processors configured to perform the operations of: maintaining a marketplace, comprising one or more servers, for securitized intellectual property (IP) comprising a plurality of users, each associated with an account; receiving a request from an authorized entity to register a security within the marketplace, the security being associated with one or more specified IP assets; registering the security within the marketplace, wherein registering comprises: receiving an escrow account for the security, executing a contract stipulating that all gross revenue from the IP assets is to be paid into the escrow account for distribution to one or more security owners, and generating a plurality of shares for the security for exchange within the marketplace; publicly listing, within the marketplace, one or more of the shares for the security based on a request from the authorized entity to list the shares; and depositing, at specified intervals, gross revenue pertaining to the security into the escrow account.

Example 64. The method of Example 63, wherein the IP asset represents one or more of: a patent, a pending patent application, and/or a peer-reviewed article.

Example 65. The method of any one of Examples 63-64, further comprising: distributing, at a specified time interval, funds from the escrow account as dividends that are divided among the security owners.

Example 66. The method of any one of Examples 63-65, wherein the authorized entity retains a majority stake in the security as a security owner.

Example 67. The method of any one of Examples 63-66, wherein the contract is a smart contract.

Example 68. The method of any one of Examples 63-67, wherein the contract further stipulates that the authorized entity agrees not to enter into any other contract with respect to distribution of gross revenue from the IP assets.

Example 69. The method of any one of Examples 63-68, wherein generating the plurality of shares for the security comprises generating a positive integer number of shares for the security such that the shares of the security cannot be fractionalized.

Example 70. The method of any one of Examples 63-69, wherein the quantity of the plurality of shares for the security cannot be modified once the shares have been generated.

Example 71. The method of any one of Examples 63-70, further comprising: receiving a request to modify the total number of shares for the security within the marketplace; and rejecting the request.

Example 72. The method of any one of Examples 63-71, further comprising: receiving a request to distribute one or more of the shares for the security to one or more compensated employees of the authorized entity; and distributing the shares to the compensated employees via the marketplace.

Example 73. The method of any one of Examples 63-72, wherein the plurality of shares for the security are listed within the marketplace along with one or more pieces of information pertaining to the security.

Example 74. The method of any one of Examples 63-73, wherein the information comprises one or more of: type of IP asset associated with the shares, reputation of the issuer of the shares, and skill of the compensated employees associated with the IP asset.

Example 75. The method of any one of Examples 63-74, further comprising: paying, at specified intervals, at least a subset of the revenue in the escrow account to shareholders of the security as dividend payments.

Example 76. The method of any one of Examples 63-75, further comprising: prior to generating the plurality of shares for the security, reviewing the one or more specified IP assets associated with the security for approval to be listed within the marketplace.

Example 77. The method of any one of Examples 63-76, further comprising: determining a nominal fair value for the security, the nominal fair value representing a value for purchasing a reserve of shares of the security in order to provide liquidity to the market.

Example 78. The method of any one of Examples 63-77, wherein the determination is performed via one or more artificial intelligence (AI) models, wherein the inputs to the one or more AI models comprise one or more of: the authorized entity associated with the security, one or more employees of the authorized entity who worked on the one or more IP assets associated with the security, one or more security owners, one or more exchange-traded funds (ETFs) which contain the security, and buy-side and sell-side pressure and volume for the security.

Example 79. The method of any one of Examples 63-78, wherein the outputs of the one or more AI models comprise one or more of: a valuation model for an arbitrary security, and volume and volatility predictions for the securities.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method, comprising:
receiving, within a marketplace for securitized intellectual property (IP), the marketplace comprising one or more servers, a trading request corresponding to at least a subset of a plurality of listed shares of a security associated with one or more IP assets, wherein the trading request represents one of a purchase request or a sale request;
calculating, via the one or more servers, a total price for the trading request based on the subset of shares in the trading request; and
processing, via the one or more servers, the trading request by:
generating, via the one or more servers, a unique token for the trading request;
executing, via the one or more servers, a transfer of the shares from a seller of the shares to a clearinghouse application;
executing, via the one or more servers, a transfer of currency in the amount of the purchase price from a buyer to the clearinghouse application; and
executing, via the one or more servers, a transfer of the shares from the clearinghouse application to the buyer and a transfer of the currency from the clearinghouse application to the seller.

2. The method of claim 1, further comprising:
receiving a determination from the clearinghouse application that the trading request pertains to a trade that would lead to a change in the price of the security beyond a price change threshold; and
based on the determination, rejecting the trading request.

3. The method of claim 1, further comprising:
receiving a determination from the clearinghouse application that the trading request constitutes a request to lend shares to a borrower; and
based on the determination, rejecting the trading request.

4. The method of claim 1, wherein the unique token comprises a unique transaction identification (ID) number.

5. The method of claim 1, wherein the unique token for the trading request is associated with at least one of: the user account of a buyer within the marketplace, a purchase price for the trading request, and one or more sources of the purchased shares.

6. The method of claim 5, wherein the one or more sources of the purchased shares are each associated with unique tokens different from the unique token associated with the trading request.

7. The method of claim 1, further comprising:
receiving a request for a compliance report for the completed trade based on the trading request; and
upon receiving the request for the compliance report:
generating a report of the cost basis of the shares within the trading request based on the information associated with the trading request, and
sending the report to one or more regulatory agencies for compliance purposes.

8. The method of claim 1, wherein the currency accepted by the clearinghouse is a cryptocurrency, and wherein the purchase price is denominated in the cryptocurrency.

9. The method of claim 8, wherein the transfer of the cryptocurrency is performed via a wallet associated with a buyer account.

10. The method of claim 1, further comprising:
writing details of the trade to a blockchain as a block representing a discrete transaction, wherein the blockchain is accessible to at least all users within the exchange who are listed as traders.

11. The method of claim 10, further comprising:
performing a verification check of one or more of the trade details on the blockchain, the trade details comprising at least the purchase price for the trade and availability of funds associated with the buyer.

12. The method of claim 11, further comprising:
marking the verification check as failed based on detecting, during the verification check, evidence of one or more of: fraud, market manipulation, and insufficient funds.

13. The method of claim 11, wherein performing the verification check comprises receiving a manual approval for the trade if the purchase price for the trade exceeds a specified threshold price for manual approval.

14. The method of claim 1, further comprising:
depositing, at specified intervals, revenue pertaining to the IP security into an escrow account pertaining to the security.

15. The method of claim 14, further comprising:
receiving a request to withdraw at least a subset of the revenue from the escrow account; and
withdrawing, based on the withdrawal request, at least a subset of the revenue from the escrow account to a wallet associated with the seller.

16. The method of claim 15, wherein withdrawing the at least subset of revenue from the escrow account is performed upon verification that one or more withdrawal conditions are satisfied.

17. The method of claim 16, wherein the withdrawal conditions comprise one or more of: revenue needing to be withdrawn for litigation purposes, and revenue needing to be paid out to shareholders as dividend payments.

18. A system comprising one or more processors configured to perform the operations of:
receiving, within a marketplace for securitized intellectual property (IP), the marketplace comprising one or more servers, a trading request corresponding to at least a subset of a plurality of listed shares of a security associated with one or more IP assets, wherein the trading request represents one of a purchase request or a sale request;
calculating, via the one or more servers, a total price for the trading request based on the subset of shares in the trading request; and
processing the trading request by:
generating, via the one or more servers, a unique token for the trading request;
executing, via the one or more servers, a transfer of the shares from a seller of the shares to a clearinghouse application;
executing, via the one or more servers, a transfer of currency in the amount of the purchase price from a buyer to the clearinghouse application; and
executing, via the one or more servers, a transfer of the shares from the clearinghouse application to the buyer and a transfer of the currency from the clearinghouse application to the seller.

19. The system of claim 18, wherein the one or more processors are further configured to perform the operations of:
executing a cryptographic signing of the trade associated with the trading request, the cryptographic signing being executed using a private key associated with an account of the buyer; and
verifying that the trade associated with the trading request has been cryptographically signed, the verification being performed using a public key associated with the account of the seller.

20. A non-transitory computer-readable medium containing instructions, comprising:
instructions for receiving, within a marketplace for securitized intellectual property (IP), a trading request corresponding to at least a subset of a plurality of listed shares of a security associated with one or more IP assets, wherein the trading request represents one of a purchase request or a sale request;
instructions for calculating a total price for the trading request based on the subset of shares in the trading request; and
instructions for processing the trading request by:
generating a unique token for the trading request;
executing a transfer of the shares from a seller of the shares to a clearinghouse application;
executing a transfer of currency in the amount of the purchase price from a buyer to the clearinghouse application; and
executing a transfer of the shares from the clearinghouse application to the buyer and a transfer of the currency from the clearinghouse application to the seller.
